(19) United States
(12) Patent Application Publication
(10) Pub. No.: US 2006/0160453 A1
(43) Pub. Date: Jul. 20, 2006

(54) Breathable composite sheet

(76) Inventor: Hageun Suh, Nashville, TN (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/328,527

(22) Filed: Jan. 10, 2006

Related U.S. Application Data
(60) Provisional application No. 60/643,879, filed on Jan. 14, 2005.

(51) Int. Cl. B32B 27/02; B32B 5/26; D04H 1/46; B32B 27/12

(52) U.S. Cl. 442/389; 442/79; 442/86; 442/164; 442/415; 442/416; 442/394; 442/408; 442/381

(57) ABSTRACT

A liquid repellent breathable composite sheet is formed by extrusion coating a thin, non-porous moisture vapor permeable film on an absorbent nonwoven layer and adhesively laminating a repellent nonwoven layer to the side of the film opposite the absorbent layer. The composite sheet has excellent viral and bacterial barrier properties and is suitable for medical uses including surgical gowns and drapes.

### BACKGROUND OF THE INVENTION

1. Field of the Invention

The present invention relates to breathable composite sheets having an improved combination of moisture vapor transmission rate, viral barrier, and liquid repellency suitable for use in medical products such as surgical gowns and drapes.

2. Description of the Related Art

It is known in the art to use moisture vapor permeable (breathable) sheets to fabricate medical products such as surgical gowns and drapes and personal care absorbent articles such as diapers where a combination of breathability, bacterial and viral barrier, and liquid barrier properties are desired. U.S. Pat. No. 6,187,696 to Lim, et al. describes composite sheets that combine a breathable film having a thickness less than 25 micrometers and a fibrous substrate to form a breathable composite sheet structure. The film is extrusion coated onto a relatively smooth side of the fibrous substrate. Examples of suitable fibrous substrates include thermally bonded carded webs and spunbond webs. U.S. Pat. No. 6,638,605 to Ankuda, Jr. et al. describes laminates suitable for use in disposable surgical drapes and gowns comprising a breathable film layer adhesively bonded between two nonwoven layers. The nonwoven may be wet laid, dry laid, spunlaced, or spunbond-meltblown-spunbond nonwoven fabrics.

It would be desirable to provide a breathable composite sheet having improved moisture vapor transmission rate and barrier to liquids, bacteria, and viruses that can be produced economically.

### BRIEF SUMMARY OF THE INVENTION

This invention is directed to a moisture-vapor permeable composite sheet made of

an absorbent fibrous nonwoven layer having two opposing surfaces, and comprising between about 0 weight percent and 95 weight percent of synthetic thermoplastic fibers, and between about 100 weight percent and 5 weight percent of absorbent fibers;

a repellent nonwoven layer having two opposing surfaces, the repellent nonwoven layer comprising synthetic fibers that comprise a repellent composition; and

a nonporous liquid impervious moisture vapor permeable film layer having a thickness no greater than about 25 micrometers sandwiched between the repellent nonwoven layer and the absorbent nonwoven layer.

### BRIEF DESCRIPTION OF THE DRAWINGS

FIG. 1 is a schematic cross-sectional view of a multi-layer composite sheet according to the present invention.

### DETAILED DESCRIPTION OF THE INVENTION

The terms “nonwoven fabric”, “nonwoven sheet”, “nonwoven layer”, and “nonwoven web” as used herein refer to a structure of individual strands (e.g. fibers, filaments, or threads) that are positioned in a random manner to form a planar material without an identifiable pattern, as opposed to a knitted or woven fabric. The term “fiber” is used herein to include staple fibers as well as continuous filaments. Examples of nonwoven fabrics include meltblown webs, spunbond nonwoven webs, flash spun webs, staple-based webs including carded and air-laid webs, spunlaced webs, and composite sheets comprising more than one nonwoven web.

The term “spunlaced nonwoven web” as used herein refers to a nonwoven fabric that is produced by entangling fibers in the web to provide a strong fabric that is free of binders. For example, a spunlaced fabric can be prepared by supporting a nonwoven web of fibers on a porous support such as a mesh screen and passing the supported web underneath water jets, such as in an hydraulic needling process. The fibers can be entangled in a repeating pattern.

The term “powder-bonded nonwoven web” as used herein refers to a bonded nonwoven fabric formed by depositing a powder adhesive onto an unbonded fibrous web, such as a carded web, such that the powder adhesive is distributed throughout the thickness of the fibrous web. A powder adhesive is selected which melts at a temperature below the melting point of the fibers in the fibrous web. Thereafter, the powder-containing web is heated to melt the powder adhesive without melting the fibers of the fibrous web to form a powder-bonded nonwoven web.

The term “spunbond fibers” as used herein means fibers that are melt-spun by extruding molten thermoplastic polymer material as fibers from a plurality of fine, usually circular, capillaries of a spinneret with the diameter of the extruded fibers then being rapidly reduced by drawing and then quenching the fibers.

The term “meltblown fibers” as used herein, means fibers that are melt-spun by meltblowing, which comprises extruding a melt-processable polymer through a plurality of capillaries as molten streams into a high velocity gas (e.g. air) stream.

The term “spunbond-meltblown-spunbond nonwoven fabric” (“SMS”) as used herein refers to a multi-layer composite sheet comprising a web of meltblown fibers sandwiched between and bonded to two spunbond layers. Additional spunbond and/or meltblown layers can be incorporated in the composite sheet, for example spunbond-meltblown-meltblown-spunbond webs (“SMMS”), etc.

The term “multiple component fiber” as used herein refers to a fiber that is composed of at least two distinct polymeric components that have been spun together to form a single fiber. The at least two polymeric components are arranged in distinct substantially constantly positioned zones across the cross-section of the multiple component fibers, the zones extending substantially continuously along the length of the fibers.

The term “bicomponent fiber” is used herein to refer to a multiple component fiber that is made from two distinct polymer components, such as sheath-core fibers that comprise a first polymeric component forming the sheath, and a second polymeric component forming the core; and side-by-side fibers, in which the first polymeric component forms at least one segment that is adjacent to at least one segment formed of the second polymeric component, each segment being substantially continuous along the length of the fiber with both polymeric components being exposed on the fiber surface. Multiple component fibers are distinguished from fibers that are extruded from a single homogeneous or heterogeneous blend of polymeric materials. The term “multiple component nonwoven web” as used herein refers to a nonwoven web comprising multiple component fibers. A multiple component web can comprise single component and/or polymer blend fibers in addition to multiple component fibers.

The term “repellent nonwoven layer” as used herein refers to a nonwoven layer having an alcohol repellency of at least 2 when measured according to INDA IST 80.8, which is hereby incorporated by reference.

As used herein, the term “pinholes” means small holes inadvertently formed in a film either during manufacture or processing of the film.

The term “polyester” as used herein is intended to embrace polymers wherein at least 85% of the recurring units are condensation products of dicarboxylic acids and dihydroxy alcohols with linkages created by formation of ester units. This includes aromatic, aliphatic, saturated, and unsaturated di-acids and di-alcohols. The term “polyester” as used herein also includes copolymers (such as block, graft, random, and alternating copolymers), blends, and modifications thereof. A common example of a polyester is poly(ethylene terephthalate) (PET) that is a condensation product of ethylene glycol and terephthalic acid.

The present invention relates to a breathable composite sheet comprising an absorbent fibrous layer, a repellent fibrous layer, and a non-porous (monolithic) breathable film layer that is substantially free of pinholes intermediate the fibrous layers. The breathable film layer is extrusion coated onto a side of the absorbent fibrous layer, followed by adhesive lamination of the repellent fibrous layer to the side of the breathable film opposite the absorbent fibrous layer.

The absorbent fibrous nonwoven layer comprises between about 0 and 95 weight percent of thermoplastic synthetic fibers and between about 100 and 5 weight percent of absorbent fibers. The range of fiber content can extend from between about 30 and 70 weight percent of thermoplastic synthetic fibers to between about 70 and 30 weight percent of absorbent fibers. The percentages are calculated based on the total weight of fibers in the fibrous layer. A nonwoven web is generally considered to be an absorbent fibrous nonwoven layer if it is wet by water when a drop of water is placed on the fabric. For purposes of this invention, a fabric is deemed not absorbent if the shape and form of a drop of water placed on the fabric does not change within about 5 minutes after placing the drop of water on the fabric, that is the fabric is not wet by the water droplet. Otherwise, the fabric is deemed absorbent.

In one embodiment, the absorbent and synthetic fibers used to prepare the absorbent nonwoven layer comprise staple fibers. Examples of suitable staple-fiber nonwovens include spunlaced nonwoven webs and powder-bonded nonwoven webs. The hydroentangling (or hydraulic needling) process for producing spunlaced nonwoven fabrics is well known in the art. In a hydroentangling process, a fibrous web is positioned on a screen or other type of apertured support and subjected to a series of high-pressure water jets that cause entangling of the fibers to form a spunlaced nonwoven fabric. Conventional hydroentangling processes can be used to prepare spunlaced fabrics suitable for use in the absorbent nonwoven layer of the present invention and are described in U.S. Pat. Nos. 3,485,706, to Evans and U.S. Pat. No. 4,891,262 to Nakamae et al., the entire contents of which are incorporated herein by reference. Powder-bonded nonwoven webs can be prepared using methods known in the art, such as the process described in U.S. Pat. No. 4,845,583 to Zimmerman et al., which is hereby incorporated by reference. A thermoplastic adhesive powder is applied to a fibrous nonwoven web using a powder-depositing device. The powder drops onto the web and is distributed through the web by gravity. The weight of powder deposited in the nonwoven web is generally between about 8 and about 30 weight percent of the powder-bonded nonwoven web. The fibrous web containing the powder is heated to bond the web. For example, the web can be passed through an oven, such as an infrared oven, in which the adhesive powder fuses and bonds the fibers. Upon leaving the oven, the web is generally subjected to light pressure in a nip.

Alternately, the absorbent fibrous nonwoven layer can be a thermally bonded carded web or an air laid web comprising a blend of absorbent fibers and thermoplastic synthetic fibers. The thermoplastic fibers can consist essentially of binder fibers or can comprise a blend of binder fibers and higher melting thermoplastic fibers. Binder fibers are thermally bondable (i.e. meltable or partially meltable) at a temperature below that of the degradation or melting point of other fibers in the web. Binder fibers can be single component fibers or can comprise multiple component fibers. The webs can be thermally bonded using methods known in the art such as full-surface or intermittent calender bonding methods.

Thermoplastic polymers suitable for preparing the synthetic fibers suitable for use in the absorbent fibrous nonwoven layer include polyesters such as poly(ethylene terephthalate) and poly(trimethylene terephthalate); polyethylene; polypropylene and polyamides. Absorbent fibers suitable for use in the absorbent fibrous nonwoven layer include natural cellulosic fibers, regenerated cellulosic fibers, animal fibers, absorbent synthetic fibers and blends thereof. Examples of natural cellulosic fibers include wood pulp and cotton. Examples of regenerated cellulosic fibers include rayon, acetate, and lyocell fibers. Suitable animal fibers include wool and silk fibers.

Absorbent synthetic fibers can be prepared by topical treatment of synthetic fibers with a composition comprising a surfactant. Surfactants typically comprise long-chain hydrocarbons having an affinity for oily hydrophobic materials as well as ionic groups having an affinity for water and hydrophilic materials. Alternately, hydrophilic melt additives can be blended with a polymer prior to spinning the polymer to form absorbent synthetic fibers. In another embodiment, chemical modification of a polymer to render it absorbent can be achieved by introducing polar branches or polar blocks into the polymer backbone. An example of a chemically modified absorbent fiber is Delcron® Hydrotec fiber, available from DAK Americas (Charlotte, N.C.).

The repellent nonwoven layer is formed from fibers that comprise a hydrophobic repellent composition. The fibers may be treated with a repellent prior to forming the nonwoven layer, or a pre-formed fibrous nonwoven layer can be treated with a repellent. Repellent compositions suitable for use as topical treatments generally include fluorochemicals, wax, and silicone-based long chain hydrocarbons. When the composite sheet of the present invention is used in medical fabrics, such as garments and drapes, the repellent composition preferably comprises a fluorochemical. Suitable fluorochemicals include Zonyl® fluorochemicals, available from E. I. du Pont de Nemours and Company, Wilmington, Del. (DuPont). Alternately, a repellent composition can be added to a polymer system as a melt additive prior to extruding repellent fibers. An example of a suitable repellent melt additive is FX1801 fluorochemical, available from Minnesota Mining and Manufacturing Company (St. Paul, Minn.). Repellent nonwoven layers suitable for use in the present invention have an alcohol repellency of at least 2, more preferably at least 6, when measured according to INDA IST 80.8.

Nonwoven substrates suitable for forming the repellent nonwoven layer include spunbond and spunbond-meltblown-spunbond nonwoven webs. The repellent nonwoven layer can comprise single component and/or multiple component fibers, such as bicomponent fibers. In one embodiment, the nonwoven substrate used to form the repellent nonwoven layer comprises a multiple component spunbond web, such as a bicomponent spunbond web. For example, the repellent layer can be formed from a bicomponent spunbond web comprising bicomponent fibers of polyethylene and polyester. Polyethylenes, such as linear low density polyethylene, provide a soft fabric while polyesters, such as poly(ethylene terephthalate) provide strength. In one embodiment, the spunbond fibers comprise a polyethylene sheath and a polyester core. In addition to providing a soft fabric, polyethylene has a relatively low melting point compared to other polymers, making it easy to bond the nonwoven web to itself or other substrates using thermal bonding.

The absorbent and repellent nonwoven fibrous substrates are selected to provide the desired strength, permeability, and softness properties to the composite sheet. The absorbent and repellent nonwoven layers generally have a basis weight between about 0.5 and 2 oz/yd².

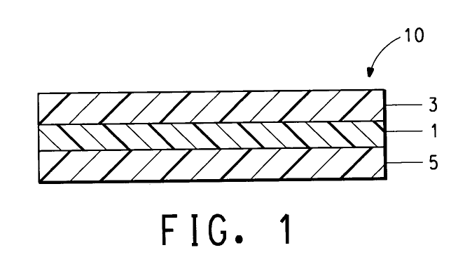

FIG. 1 is a schematic cross-sectional view of a multi-layer composite sheet according to the present invention. Nonporous liquid impervious moisture vapor permeable film layer 1 is sandwiched between absorbent fibrous nonwoven layer 3 and repellent nonwoven layer 5. Film 1 can be a single layer or a multi-layer film. The multi-layer moisture-vapor permeable composite sheets of the present invention are prepared by forming a nonporous liquid impervious moisture vapor permeable film layer on one side of the absorbent nonwoven layer by extrusion coating, followed by adhesive lamination of the repellent nonwoven layer to the side of the film opposite the absorbent nonwoven layer. The adhesive layer is intermediate to the repellent nonwoven layer 5 and film layer 1 and is not shown in FIG. 1.

Film layer 1 comprises a polymeric material that can be extruded as a thin, continuous, moisture vapor permeable, and substantially liquid impermeable film. The film layer is extruded directly onto the absorbent nonwoven layer in an extrusion coating process and is less than about 1 mil (25 micrometers) thick, more preferably less than about 0.75 mil (19 micrometers) thick, and most preferably less than about 0.60 mil (15.2 micrometers) thick. The film layer 1 is preferably comprised of a block polyether copolymer such as a block polyether ester copolymer, a polyetheramide copolymer, a polyurethane copolymer, a poly(etherimide) ester copolymer, polyvinyl alcohols, or a combination thereof. Preferred copolyether ester block copolymers are segmented elastomers having soft polyether segments and hard polyester segments, as disclosed in Hagman, U.S. Pat. No. 4,739,012. Suitable copolyether ester block copolymers are sold by E. I. du Pont de Nemours and Company (Wilmington, Del.) under the name Hytrel®. Suitable copolyether amide polymers are copolyamides available under the name Pebax® from Atochem Inc. of Glen Rock, N.J., USA. Suitable polyurethanes are thermoplastic urethanes available under the name Estane® from The B. F. Goodrich Company of Cleveland, Ohio, USA. Suitable copoly(etherimide) esters are described in Hoeschele et al., U.S. Pat. No. 4,868,062.

In an extrusion coating process, a uniform (monolithic, i.e. substantially free of pinholes) molten extrudate is coated onto the absorbent nonwoven layer. The molten polymer and the absorbent nonwoven web are brought into intimate contact as the molten polymer cools and bonds with the web. Such contact and bonding can be enhanced by passing the layers through a nip formed between two rolls. Alternatively, the molten polymer can be pulled into contact with the powder-bonded nonwoven web by passing the coated web over a suction inlet such that a vacuum pulls the molten polymer into contact with the web as the polymer cools and bonds with the web. The extruded film layer is substantially free of pinholes or other defects, yet has a relatively high rate of moisture vapor transmission. Extrusion coating methods are known in the art, such as methods described in US Patent Application Publication No. 2002/0106959, which is hereby incorporated by reference.

The film layer 1 (FIG. 1) of the composite laminated sheet can be comprised of multiple layers. Such a film may be co-extruded with layers comprised of one or more of the above-described breathable thermoplastic film materials. Examples of such multiple layer moisture vapor permeable films, which typically comprise a comparatively more hydrophobic elastomer layer and a comparatively more hydrophilic elastomer layer, are disclosed in Ostapchenko, U.S. Pat. No. 4,725,481. In a preferred embodiment, a multi-layer film (in a bi-layer execution) is extruded onto the absorbent nonwoven layer with the comparatively more hydrophobic elastomer layer facing outwardly from the absorbent nonwoven layer and the comparatively more hydrophilic elastomer layer bonded to the absorbent nonwoven layer. Typically, for a given thickness, the hydrophobic elastomer layer exhibits a lower moisture vapor transmission rate than the hydrophilic elastomer layer due to its comparatively lower moisture content under in-use conditions. However, when employed in a comparatively thin layer, the effect of the hydrophobic lower moisture content film layer does not significantly diminish the moisture vapor transmission rate of the composite laminated sheet. Preferably, the comparatively more hydrophobic elastomer comprises between 20 and 30 percent of the total thickness of the composite film layer.

The repellent nonwoven layer is joined to the film side of the extrusion-coated film/absorbent nonwoven bi-laminate using an adhesive that has been applied in discrete areas such that the two components are bonded intermittently to each other. For example, the adhesive can be applied in a pattern or as randomly oriented filaments. The adhesive is preferably applied at about 1 g/m² to 6 g/m². If the adhesive loading is too high, the composite laminated sheet will be stiffer than desired. If it is too low, the bond strength between the film and the repellent nonwoven layer will be too low. The adhesive is preferably a heat sensitive hot melt adhesive such as hot melt adhesives based on polystyrene-polybutadiene-polystyrene (SBS) or polystyrene-polyisoprene-polystyrene (SIS). Conventional adhesive lamination methods can be used such as meltblowing, screen, or gravure adhesive lamination methods. In a meltblowing adhesive lamination process, adhesive is deposited as random molten meltblown fibers onto either the film layer or the repellent nonwoven layer. In a screen or gravure adhesive lamination process the hot melt adhesive is applied through patterned or engraved areas. Bonding between the film layer and the repellent nonwoven layer can generally be improved by depositing the hot melt adhesive on the film layer; however this can result in a tendency to form pinholes in the film due to the high temperature of the hot melt adhesive when it contacts the film. Depositing the hot melt adhesive on the repellent nonwoven layer can result in a reduction in bond strength compared to when the adhesive is deposited on the film layer, however proper selection of the repellent nonwoven layer provides acceptable bonding for most end uses while reducing the chance for pinhole formation. The film layer and repellent nonwoven layer are contacted prior to cooling of the hot melt adhesive and passed through a nip formed between two rolls. Alternately, an adhesive web formed from a hot melt adhesive composition can be positioned intermediate the repellent nonwoven layer and the extrusion-coated film/absorbent nonwoven bi-laminate, and the layers bonded together by passing the combined layers through a heated nip formed between two rolls to form a moisture-vapor permeable composite sheet according to the present invention.

The moisture-vapor permeable composite sheets of the present invention preferably have a moisture vapor transmission rate of at least about 3000 g/m²/24 hr, more preferably at least about 4000 g/m²/24 hr. The sheets must have sufficient viral barrier properties to meet the requirements of ASTM F1670 and F1671. Further, the inventive sheets have a wicking rate of less than 100 seconds and preferably less than 60 seconds. The composite laminates of the present invention are suitable for use in medical fabrics such as garments and drapes. When used to fabricate garments, the garment is manufactured such that the absorbent nonwoven layer forms the inner layer of the garment, which is adjacent to the wearer during use and the repellent nonwoven layer forms the outer surface of the garment. The composite laminates are also suitable for use in a number of other applications in which moisture vapor permeability in combination with liquid impermeability is important, such as protective covers for automobiles, crops, housewrap, and roofliner. The viral barrier characteristics of the present invention also lend it to use in protective apparel other than medical garments, such as protective apparel to prevent particulate penetration, such as asbestos; protection from other biological agents such as bacteria; protection from harmful liquid penetration, such as harsh chemicals; and cleanroom garments. Likewise, the composite laminates of the present invention can find use in personal care articles, such as diapers, sanitary napkins and the like. The vapor permeability of the present invention lends it to use in steam sterilization wraps for wrapping surgical instruments and supplies for sterilization. The absorbent inner layer can provide the additional comfort and the possible applications can be medical gowns and drapes, protective garments and personal care products where the absorbent properties are needed.

### Test Methods

In the description above and in the non-limiting examples that follow, the following test methods were employed to determine various reported characteristics and properties. ASTM refers to the American Society for Testing and Materials. TAPPI refers to the Technical Association of Pulp and Paper Industry. ISO refers to the International Organization for Standardization. INDA refers to Association of the Nonwoven Fabrics Industry.

Thickness was determined by ASTM Method D177-64, which is here by incorporated by reference, and is reported in mils.

Basis weight was determined by ASTM D-3776, which is hereby incorporated by reference, and is reported in oz/yd² (osy).

Grab Tensile Strength (GTS) was determined by ASTM D 5034-95, which is hereby incorporated by reference, was measured in pounds.

Trap Tear Strength (TTS) was measured by ASTM D 5733, in which trapezoid tear strength was recorded in pounds as the maximum tearing force required to continue or propagate a tear started previously in the sample. In this study, the average tearing strength from the initiation to the end of testing was taken as the Trap Tear.

Bond Strength (BS) was measured according to a test that generally follows the method of ASTM D2724-87, which is hereby incorporated by reference. The test was performed used a constant rate of extension tensile testing machine such as an Instron table model tester. A 5 cm (2.0 in) by 20.32 cm (8.0 in) sample was delaminated approximately 3.18 cm (1.25 in) by initiating a separation between the fibrous web and the moisture vapor permeable film. The separated sample faces were mounted in the clamps of the tester that are set 5.08 cm (2.0 in) apart. The tester was run at a crosshead speed of 30.5 cm/min (12.0 in/min). The samples were delaminated for about 10 cm (4 in) during which sufficient readings are taken to provide a representative average of the data. The averages of bond strengths between 2″ and 4″ separation were taken as average bond strength in grams. By divided by two inches, the average bond strengths were obtained in grams/inch.

Hydrostatic head (HH) was measured according to IST 80.4, which measures the resistance to water penetration on a test sample with a 100 cm² circular area. Water pressure is applied to the fabric side of the test specimen until the sample is penetrated by water at three places. The hydrostatic pressure is measured in centimeters. For the film based laminate products in this study, a supporting screen material was used to prevent the laminates from tearing and stretching the materials.

Viral Barrier properties were measured according to ASTM F1671, which is hereby incorporated by reference. ASTM F1671 is a standard test method for measuring the resistance of materials used in protective clothing to penetration by blood-borne pathogens. According to this method, three samples of a sheet material being tested are challenged with 108 Phi-X174 bacteriophage, similar in size to the Hepatitis C virus (0.028 micrometers) and with a surface tension adjusted to 0.042 N/m, at a pressure differential of 2 psi (13.8 kPa) for a 24 hour period. Penetration of the sample by viable viruses is determined using an assay procedure. The test results are reported in units of Plaque Forming Units per milliliter PFU/ml. A sample passes if zero PFU/ml were detected after the 24 hour test period.

ASTM F1670 was used for measuring the resistance of the liquid penetration by synthetic blood. The same test equipment was used for ASTM F1671 but a synthetic blood solution was used for the challenged solution. The same pressure, 2 psi, was applied. A sample failed the test if the visual penetration was observed.

Moisture Vapor Transmission Rate (MVTR) was measured with a Mocon Permatran—W model 100K Instrument by IST 70.4. The MVTR numbers, the rates of water vapor flow normal to the surfaces per unit area at 37.8° C. and 60% RH, were reported in g/m²¹²⁴ hrs.

Wicking was measured according to IST 10.1. A 25 mm wide and 100 mm long sample was cut and immersed to water vertically. The time for water to rise 25 mm (1 inch) was measured in seconds.

Absorbent Capacity (AC) was measured by a GATS (Gravimetric absorbency Testing) system, Model M/K201 from M/K Systems, Inc. A two-diameter sample was cut, weighed and placed on the tester. Once the water was introduced to the sample, the percent absorbent capacity was obtained based on the calculation of total water absorbed divided by the sample weight.

Alcohol Repellency (AR) was measured by INDA IST 80.8. IST 80.8 is a standard test method for measuring the resistance of nonwoven fabrics to penetration by aqueous isopropanol solutions. The alcohol repellency was reported in ratings based upon alcohol concentrations. The highest number of test solution that did not penetrate the test specimen within five minutes was recorded.

Electrostatic Decay was measured according to INDA IST 40.2, which is hereby incorporated by reference. IST 40.2 is a standard test method for measuring the time required to dissipate a charge from the surface of a test specimen. The test sample was charged by positive or negative high voltage (5000V) and time for the charge dissipation was measured. The electrostatic decay was reported in seconds.

### EXAMPLES

### Examples 1-5

In these examples, three different powder-bonded nonwoven layers were used as the absorbent inner layer, the layer next to the breathable film layer, having a basis weight of 1.0 oz/yd² (34 g/m²) (obtained from HDK Company, Greenville, S.C.). The powder-bonded nonwoven layers were formed from the blends of polyester (poly(ethylene terephthalate) and rayon staple fibers with three different blend ratios, 70/30, 50/50 and 30/70 rayon/polyester by weight. A copolyester powder adhesive was used at a loading of 20 percent by weight based on the total weight of the powder adhesive and staple fibers in the nonwoven webs.

To form bilaminate composite structures, the powder-bonded nonwoven webs were extrusion coated with a polymer film layer of Hytrel® copolyether ester, a breathable membrane film layer. The Hytrel® film layer was coextruded with three layers of blends of percent of Hytrel G4778 (melting point 208° C., vicat softening temperature of 175° C., a Shore D hardness of 47, and a water absorption of 2.3 wt %) and Hytrel® 8206 (melting point 200° C., vicat softening temperature of 151° C., a Shore D hardness of 45, and a water absorption of 30 wt %), both available from DuPont. The three layers of Hytrel® were formed with two outside layers consisting of greater than 50% G4778, 8206, and color pigment and the inner layer consisting of 8206, color pigment and TiO₂. The thickness of the inner layer was about three times the thickness of each of the outer layers. The total percentages of Hytrel® G4778 and Hytrel® 8206 were 23% and 70%, respectively. The blends of two Hytrel® grades were selected in order to have an excellent balance between the breathability and softness of the bilaminates and the strength and low water absorbency of the bilaminates. Since Hytrel® 8206 has more ether than ester parts, resulting in a softer sheet material and a higher MVTR than sheet material made using Hytrel® G4778. Hytrel® G4778 has been found to provide greater strength and lower water absorbency than Hytrel® 8206. In addition to the Hytrel polymers, 5 wt % of color and 2 wt % of TiO₂ concentrates were added for color and opacity.

The Hytrel® polymer and the additive concentrates were fed in pellet forms into two screw extruders, melted at a temperature in the range of 440° F. (227° C.) to 385° F. (196° C.), and fed to a die opening in a heated die block maintained at 430° F. (221° C.). The powder-bonded nonwoven substrate was spaced about 19.5 inches (49.5 cm) below the opening of the die. The film was extruded at a rate of 325 ft/min (99 m/min) to obtain a film thickness of 0.7 mil (18 micrometers). For a film thickness of 0.8 mil (20 micrometers), the line speed was decreased at a rate of 280 ft/min (85 m/min). The film was joined to the fibrous powder-bonded nonwoven substrate by passing the coated web through a pair of horizontally positioned nip rolls with a nip roll pressure of 10 psi to form a composite laminated sheet. The nip roll that faced the polymer melt was a silicone rubber roll having a matte finish and the other roll was metal. A quench bath was located adjacent to the rubber roll on the side of the roll opposite the metal roll and was maintained at a temperature of 80° F. (27° C.).

Five examples of the bilaminates were fabricated based on two film thicknesses (0.7 mil and 0.8 mil) and three fiber blend ratios (70/30, 50/50, and 30/70 rayon polyester) of the powder bonded nonwovens (Table 1).

To form the trilaminate composite structures, a repellent spunbonded polyester/polyethylene bicomponent nonwoven fabric having a basis weight of 1.0 oz/yd² was adhesively bonded to the Hytrel® film layer of the two-layered composites described above. The spunbond bicomponent fabric was a sheath/core structure of 50% linear low-density polyethylene (LLDPE)/50% poly(ethylene terephthalate (PET) and was pre-bonded by thermal calendering. For alcohol repellency and antistatic properties, the spunbonded nonwoven was topically treated with Zonyl® 7040 (a fluorochemical sold by DuPont), and Zelec TY antistatic agent (mixture of isobutyl and di-isobutyl phosphate ester, sold by Stepan Company (Northfield Ill.).

The spunbonded polyester/polyethylene nonwoven was laminated to the film side of the Hytrel® bilaminates by using meltblown adhesive lamination technology. The hot melt adhesive used in these examples was H2900 based on polystyrene-polybutadiene-polystyrene (SBS) linear block copolymers (provided by Bostik Findley located in Wauwatosa, Wis.). The add-on level of the adhesive was 5 g/m².

The hot melt adhesives were fed and melted in a hopper and transferred by an insulated hose into a hot melt meltblowing line equipped with J&M nozzles having 18 holes/inch tips. The adhesive was melt-blown onto the Hytrel® film side of the two-layered composites with a line speed of 200 ft/min, and an air pressure of 40 psi. The distance from the nozzle head to the bilaminate substrate was 1.5 inches and the lamination distance between the nozzles and the nip was 60 inches. The hopper, hose, head, and air temperatures were selected based on the melt viscosity properties of the hot melt adhesive. For H2900, hopper, hose, head, and air temperatures were 310, 320, 320 and 350° F., respectively.

All of the Examples had a hydrohead in excess of 300 seconds and passed ASTM F-1670 and F-1671. Other physical properties of the Examples are provided in Table 1 below.

### Examples 6 to 11

In these examples, spunlaced nonwoven fabrics made of the blends of polyester and lyocell fibers were used as the absorbent inner layer. The basis weight of the spunlaced nonwovens was 1.18 osy and three different blend ratios were used, 65/35, 50/50, and 35/65 lyocell/PET.

The spunlaced lyocell/PET nonwoven webs were extrusion-coated with a 3-layer polymer film of Hytrel® 4778 and Hytrel® 8206 using the same processing conditions described in Examples 1 to 5. Six examples of the absorbent nonwoven/film bilaminates were fabricated based on two film thicknesses (0.7 mil and 0.8 mil) and three blend ratios (65/35, 50/50, and 35/65 lyocell/polyester) of the spunlaced nonwovens (Table 1).

To form trilaminate composite structures of the present invention, the bilaminates from the aforementioned extrusion coating process were laminated with the 1.0 osy spunbonded core/sheath polyester/polyethylene bicomponent nonwoven web by the meltblowing adhesive lamination process described in Examples 1 to 5. All of the Examples had a hydrohead in excess of 300 seconds and passed ASTM F-1670 and F-1671. Other physical properties of the Examples are provided in Table 1 below.

### Example 12

In this example, a spunlaced nonwoven fabric made of a blend of polyester and rayon fibers was used as the absorbent inner layer. The basis weight of the spunlaced nonwoven layer was 1.18 osy and the blend ratio was 30/70 by weight rayon/PET.

The spunlaced rayon/PET nonwoven web was extrusion-coated with a 3-layer polymer film of Hytrel® 4778 and Hytrel® 8206 using the same processing conditions described in Examples 1 to 5 to have a film thickness of 0.8 ml. The trilaminate was formed using the meltblowing adhesive lamination process described in Examples 1 to 5 to bond the extrusion-coated rayon/PET-film bilaminate and the 1.0 osy spunbonded core/sheath polyester/polyethylene bicomponent nonwoven web described in Examples 1 to 5. The Example had a hydrohead in excess of 300 seconds and passed ASTM F-1670 and F-1671. Other physical properties of the Example are provided in Table 1 below.

### Comparative Examples A and B

Comparative Examples A and B were fabricated using the same extrusion coating process and the meltblowing adhesive lamination process described in Examples 1 to 5. In these examples, a nonabsorbent inner layer was used instead of an absorbent inner layer. The non-absorbent inner layers used were a 0.5 osy powder bonded 100% polyester nonwoven web and 1.0 osy spunbonded polyester/polyethylene web having the film thicknesses of 0.6 mil and 0.7 mil for Comparative Examples A and B, respectively. Both Comparative Examples had a hydrohead in excess of 300 seconds and passed ASTM F-1670 and F-1671. Other physical properties are provided in Table 1 below.

Both trilaminates resulted in similar properties but the MVTR numbers were lower than those from Examples 1 to 12. Comparative Example A had lower basis weight and film thickness and Comparative Example B had the same or lower basis weight (1.0 osy) and same film thickness (0.8 mil). One might expect the MVTR values from Comparative Example A to be significantly higher and those from Comparative Example B to be at least the same as the MVTR values from the Examples 1 to 12.

However, without being necessarily limited to any theory, the higher MVTR numbers obtained for Examples 1 to 12 might result from having the absorbent inner layer next to the breathable layer, which can create an accelerated driving force to the moisture vapors absorbed or transported to the film layer at the faster rate. The diffusion mechanism of the moisture vapor transporting through a breathable film layer can be governed by many factors including thickness. One factor observed by this invention was that a higher humidity environment can be created by moisture vapors absorbed by an absorbent inner layer. This higher humidity environment adjacent to the breathable film may enhance the breathability (MVTR), which can be explained by diffusion mechanism by greater density gradients of moisture vapors. Using an absorbent inner layer according to the present invention may improve the comfort properties by enhanced breathability.

The test results of Examples 1 to 12 and the Comparative Examples are set forth in Table 2 below.

TABLE 1

| | Ex 1 | Ex 2 | Ex 3 | Ex 4 | Ex 5 | Ex 6 | Ex 7 | Ex 8 | Ex 9 | Ex 10 | Ex 11 | Ex 12 | Ex A | Ex B |
|---|---|---|---|---|---|---|---|---|---|---|---|---|---|---|
| Inner Layer | 70/30 | 50/50 | 50/50 | 30/70 | 30/70 | 65/35 | 65/35 | 50/50 | 50/50 | 35/65 | 35/65 | 30/70 | 0.5 osy | 1.0 osy |
| | r/PET | r/PET | r/PET | r/PET | r/PET | I/PET | I/PET | I/PET | I/PET | I/PET | I/PET | r/PET | PET | PET/PE |
| Film thick | 0.7 | 0.8 | 0.7 | 0.8 | 0.7 | 0.7 | 0.8 | 0.7 | 0.8 | 0.7 | 0.8 | 0.8 | 0.6 | 0.8 |
| BW | 2.8 | 2.96 | 2.85 | 2.73 | 2.91 | 3.04 | 3.07 | 2.88 | 3.19 | 3 | 2.98 | 3.09 | 2.5 | 3.15 |
| Ex. Thick | 19 | 18 | 18 | 18 | 18 | 21 | 19 | 20 | 22 | 19 | 20 | 20 | 14 | 17 |
| GTS | 33/25 | 31/23 | 34/25 | 29/25 | 28/24 | 34/23 | 39/29 | 34/25 | 36/25 | 39/25 | 40/26 | 41/29 | 33/23 | 36/23 |
| MD/CD | | | | | | | | | | | | | | |
| TTS MD/CD | 7.1/13,5 | 8.3/13.4 | 7.9/13.0 | 8.4/14.2 | 6.8/12.8 | 7.9/14.4 | 7.6/13.4 | 8.6/13.7 | 8.2/15.5 | 8.2/15.7 | 7.4/15.7 | 9.4/17.4 | 6.6/12.9 | 8.5/11.5 |
| 2″ Strip | 29/11 | 23/11 | 27/10 | 26/13 | 23/10 | 26/14 | 22/15 | 23/16 | 24/15 | 29/12 | 28/15 | 35/14 | 21/13 | 21/11 |
| MD/CD | | | | | | | | | | | | | | |
| Inner BS | 116/55 | 58/91 | 92/81 | 103/127 | 255/72 | 113/67 | 130/78 | 172/97 | 190/118 | 275/124 | 54/82 | 112/58 | 166/128 | 23/14 |
| MD/CD | | | | | | | | | | | | | | |
| Outer BS | 275/377 | 400/320 | 406/332 | 343/369 | 392/341 | 179/177 | 620/430 | 455/387 | 344/453 | 534/333 | 271/414 | 350/280 | 414/337 | 298/327 |
| MD/CD | | | | | | | | | | | | | | |
| MVTR | 6486 | 5161 | 6224 | 5933 | 6195 | 7553 | 6199 | 5878 | 5978 | 7076 | 5620 | 5289 | 4934 | 3716 |
| Wicking | 8.4 | 7 | 23.7 | 26.7 | 63.6 | 6.8 | 6.5 | 19.5 | 12.2 | 46.4 | 38.4 | 27.2 | N/A | N/A |
| AC | 207 | 190 | 191 | 177 | 174 | 242 | 231 | 227 | 226 | 209 | 207 | 223 | N/A | N/A |

### Comparative Examples C to F

Comparative Examples C to F, as indicated in Table 2 below, are sold commercially in an application area similar to the composite laminates of Examples 1 to 5. All examples were used in the area required to have the barrier properties passing ASTM F1670/F1671 and the breathability measured by MVTR numbers. All examples were trilaminates except for Example A and are further described as follows:

Comparative Example C was Prevention, a bilaminate of a spunbond nonwoven sheet and a film layer made by thermal bonding available from Medline.

Comparative example D was MicroCool, a trilaminate of two outer spunbond nonwoven sheets and an inner film layer made by thermal bonding, available from Kimberly-Clark.

Comparative Example E was SmartGown™, a trilaminate of an outer repellent spunmelt nonwoven layer an inner film layer and an outer spunbond nonwoven layer made by adhesive lamination, available from Allegiance.

Comparative Example F was a trilaminate of an outer absorbent nonwoven layer, an inner film layer and an outer nonwoven layer made by thermal bonding.

TABLE 2

| | | Film | | | | | Alcohol | Alcohol |
|---|---|---|---|---|---|---|---|---|
| | | thickness | | | MVTR | | repellency | repellency |
| | Film layer | (mil) | ASTM F1670 | ASTM F1671 | (g/m\hat{ }2/day) | Static decay (sec. +/−) | top layer | overall |
| Exs 1 to 12 | Breathable | 0.7 or 0.8 | Pass | Pass | 5161 to 7553 | Less than 1 | 9 | 2 to 5 |
| | Membrane | | | | | | | |
| Ex A | Breathable | 0.6 | Pass | Pass | 4934 | Less than 1 | 9 | 3 |
| | Membrane | | | | | | | |
| Ex B | Breathable | 0.8 | Pass | Pass | 3716 | Less than 1 | 9 | 4 |
| | Membrane | | | | | | | |
| Ex C | Microporous film | About 1.2 | Pass | Pass | 20762 | Infinite | 1 | 1 |
| Ex D | Microporous film | About 1 | Pass | Pass | 8008 | Less than 1 | 1 | 1 |
| Ex E | Breathable | About 0.6 | Pass | Pass | 5017 | Less than 1 | 10 | 10 |
| | membrane | | | | | | | |
| Ex F | Breathable | About 1 | Fail | No data | 4182 | Less than 1 | 1 | 1 |
| | Membrane | | | | | | | |

The data in Table 2 indicates that the composite laminates utilizing repellent and absorbent layers according to the present invention demonstrate the repellent, absorbent and antistatic properties, as well as the barrier and breathability properties relative to commercially available composite laminates. Likewise, Examples 1 to 12 of the present invention have better MVTR numbers, while maintaining the barrier properties compared with laminates with a similar type of film layer, Comparative Samples E and F. Comparative Samples C, D, and E do not have the absorbency of the inner nonwoven layers. Comparative Samples C, D, and F do not have the repellency of the top layers.

What is claimed is:

1. A moisture-vapor permeable composite sheet comprising:
an absorbent fibrous nonwoven layer having two opposing surfaces, and comprising between about 0 weight percent and 95 weight percent of synthetic thermoplastic fibers, and between about 100 weight percent and 5 weight percent of absorbent fibers;
a repellent nonwoven layer having two opposing surfaces, the repellent nonwoven layer comprising synthetic fibers that comprise a repellent composition; and
a nonporous liquid impervious moisture vapor permeable film layer having a thickness no greater than about 25 micrometers sandwiched between the repellent nonwoven layer and the absorbent nonwoven layer.

2. The moisture-vapor permeable composite sheet of claim 1, wherein the absorbent fibrous nonwoven layer comprises between about 30 weight percent and 70 weight percent of synthetic thermoplastic fibers, and between about 70 weight percent and 30 weight percent of absorbent fibers.

3. The moisture-vapor permeable composite sheet of claim 1, wherein the absorbent fibrous nonwoven layer comprises thermoplastic synthetic fibers selected from the group consisting of poly(ethylene terephthalate, poly(trimethylene terephthalate, polyethylene, polypropylene and polyamide.

4. The moisture-vapor permeable composite sheet of claim 1, wherein the absorbent fibrous nonwoven layer comprises absorbent fibers selected from the group consisting of natural cellulosic fibers, regenerated cellulosic fibers, absorbent synthetic fibers, animal fibers and blends thereof

5. The moisture-vapor permeable composite sheet of claim 1, wherein the moisture vapor permeable film layer is formed by extrusion onto one surface of the absorbent nonwoven layer and one surface of the repellent nonwoven layer is adhered to the moisture vapor permeable film layer by an intermediate adhesive layer.

6. The moisture-vapor permeable composite sheet of claim 1, wherein the moisture vapor permeable film layer is selected form the group consisting of block polyether ester copolymer, polyetheramide copolymer, polyurethane copolymer, poly(etherimide) ester copolymer, polyvinyl alcohol, and combinations thereof.

7. A moisture-vapor permeable composite sheet comprising:
an absorbent fibrous nonwoven layer of staple fibers having two opposing surfaces, and
a repellent nonwoven layer having two opposing surfaces, the repellent nonwoven layer comprising synthetic fibers that comprise a repellent composition; and
a nonporous liquid impervious moisture vapor permeable film layer having a thickness no greater than about 25 micrometers sandwiched between the repellent nonwoven layer and the absorbent nonwoven layer.

8. The moisture-vapor permeable composite sheet of claim 7, wherein the absorbent fibrous nonwoven layer is powder-bonded.

9. The moisture-vapor permeable composite sheet of claim 1, wherein the absorbent fibrous nonwoven layer is hydroentangled.

10. A moisture-vapor permeable composite sheet comprising:
an absorbent fibrous nonwoven layer having two opposing surfaces, and
a nonporous liquid impervious moisture vapor permeable film layer having a thickness no greater than about 25 micrometers.

11. The composite sheet of claim 10 wherein the absorbent fibrous nonwoven layer comprises between about 0 weight percent and 95 weight percent of synthetic thermoplastic fibers and between about 100 weight percent and 5 weight percent of absorbent fibers.

12. The composite sheet of claim 11, wherein the thermoplastic synthetic fibers are selected from the group consisting of poly(ethylene terephthalate, poly(trimethylene terephthalate, polyethylene, polypropylene and polyamide and blends thereof.

13. The composite sheet of claim 11, wherein the absorbent fibers are selected from the group consisting of natural cellulosic fibers, regenerated cellulosic fibers, absorbent synthetic fibers, animal fibers and blends thereof.

14. The moisture-vapor permeable composite sheet of claim 10, wherein the absorbent fibrous nonwoven layer is powder-bonded.

15. The moisture-vapor permeable composite sheet of claim 7, wherein the absorbent fibrous nonwoven layer is hydroentangled.

16. The composite sheet of claim 10, wherein the film layer is of the composition selected from the group consisting of block polyether ester copolymer, polyetheramide copolymer, polyurethane copolymer, poly(etherimide) ester copolymer, polyvinyl alcohol, and combinations thereof.
